(19) United States
(12) Patent Application Publication
(10) Pub. No.: US 2007/0034425 A1
(43) Pub. Date: Feb. 15, 2007

(54) Method of operating a hybrid drive system

(75) Inventor: Conrad Roessel, Syrgenstein (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/554,318

(22) PCT Filed: Feb. 28, 2004
(86) PCT No.: PCT/EP04/02009

§ 371 Date: Sep. 19, 2006

(30) Foreign Application Priority Data
Apr. 25, 2003 (DE) 103 18 738.3

(51) Int. Cl. B60L 8/00; B60K 6/00

(52) U.S. Cl. 180/65.2; 180/65.3

(57) ABSTRACT

In a hybrid drive having an electric motor which can be switched between the motor mode and the generator mode, the electric motor is switched between its operating modes as a function of the differential efficiency of the internal combustion engine when the internal combustion engine is operating, in which case the generator power can then be controlled in proportion to the differential efficiency, and the motor power can be controlled in inverse proportion to the differential efficiency.

This application claims the priority of German patent document 103 18 738.3, filed Apr. 25, 2003 (PCT International Application No. PCT/EP2004/002009), the disclosure of which is expressly incorporated by reference herein.

### BACKGROUND AND SUMMARY OF THE INVENTION

The present invention relates to control of an electric motor which can be switched between a motor mode and a generator mode, is or can be coupled to an internal combustion engine, and has an associated battery. In particular the invention is suitable for use in a hybrid drive that includes an internal combustion engine and such an electric motor, with an associated battery that has a sensor system which records the state of charge of the battery. The internal combustion engine and the electric motor are or can be coupled to the output drive of the hybrid drive for drive purposes, and the electric motor can be driven by the internal combustion engine and/or the output drive during the generator mode.

Motor vehicles with hybrid drives have been in development for a relatively long time. In general, in such drives the electric motor may be continuously connected, for drive purposes, to the drive train of the vehicle, and thus to the output drive from the hybrid drive which leads to the drive train. In contrast, the internal combustion engine can be switched by means of a clutch, such that when the clutch is engaged, the internal combustion engine is connected to the drive train and to the electric motor for drive purposes, and when the clutch is disengaged, it is disconnected from the electric motor and from the drive train.

In principle, however, hybrid drives with different configurations are also known. For example, the internal combustion engine and the electric motor can be connected, via separate clutches, to the output drive of the hybrid drive, and in a corresponding manner to the drive train of the vehicle.

One particular advantage of hybrid drives is that regenerative braking is possible, in which the electric motor which is connected to the drive train is operated as a generator and is driven via the drive train, so that the power supplied to the battery in the generator mode is used for braking purposes, and is accordingly taken from the vehicle propulsion. In this way, the kinetic energy which is taken from the vehicle propulsion is converted to potential energy (that is, in this case to increased battery charge), and is not “wasted” as unusable heat as is the case in normal braking.

Furthermore, hybrid drive vehicles can be operated purely by the electric motor, and thus without any exhaust gas emissions, in highly populated areas in which it can generally be expected that the vehicle speed will be comparatively low and that stopping maneuvers will occur very frequently. Outside highly populated regions, the internal combustion engine can be used for propulsion to drive the vehicle. During these operating phases, the electric motor can be switched to the generator mode and can be driven by the internal combustion engine, so that the battery which may possibly have previously been discharged can be recharged.

In propulsion systems of this type, the generator power has heretofore been controlled as a function of the state of charge of the battery in the charging mode. See, for example, “Analysing Hybrid Drive System Topologies”, Karin Jonasson (2002), Lund University, ISBN 91-88934-23-3, page 74.

One object of the present invention is to provide a hybrid drive that has improved efficiency.

This and other objects and advantages are achieved by the control arrangement according to the invention, in which, during operating phases in which the internal combustion engine is operating and is coupled to the output drive, the electric motor operates
predominantly in the generator mode only when the load on the internal combustion engine is low,
and/or
predominantly in the motor mode when the load on the internal combustion engine is high.

The invention is based on the general idea of switching the electric motor to the generator mode as far as possible, only when the internal combustion engine is operating, and when the additional load which this causes on the internal combustion engine leads to only a comparatively small amount of additional fuel consumption. This is typically the case when the internal combustion engine is lightly loaded or is operating with high load reserves.

On the other hand, as far as possible, the electric motor is to assist the internal combustion engine in propelling the vehicle when the load reduction on the internal combustion engine which is achieved by operating the electric motor and the internal combustion engine in parallel leads to a comparatively major reduction in the fuel consumption of the internal combustion engine. This is generally the case when high power is required for the operating phase of the vehicle, and the internal combustion engine is accordingly highly loaded.

The invention also takes account of the fact that the electric motor and the battery are virtually always more efficient than the internal combustion engine. On the other hand, it is also taken into account that the fuel consumption of the internal combustion engine when highly loaded rises more than in proportion to its load. As a result, load increases on the internal combustion engine when the total load is small lead only to a relatively minor increase in the fuel consumption of the internal combustion engine, while load reductions on the internal combustion engine when the load is high result in comparatively major savings in the fuel consumption of the internal combustion engine.

The control principle according to the invention as described above can be carried out whenever the state of charge of the battery is neither above an upper threshold nor is below a lower threshold, so that the battery can be used both for feeding the electric motor in the motor mode and for storage of the electrical energy which is produced by the electric motor in the generator mode, without need to be concerned about overcharging or undercharging of the battery.

Conditions such as these are likely to occur at least during typical driving cycles, so that only in rare exceptional cases need (or should) the motor mode or generator mode of the electric motor be controlled exclusively as a function of the state of charge of the battery.

According to one preferred embodiment of the invention, in the case of an internal combustion engine/electric motor combination, or hybrid drives in which the electric motor is continuously positively coupled to the output drive, no-load operation of the electric motor avoided. That is, in such circumstances the electric motor is decoupled from the battery so that it can be operated neither in the motor mode nor in the generator mode. In fact, when the internal combustion engine is operating, the electric motor is kept either in the generator mode or in the motor mode, and is switched between these modes, with the fuel consumption of the internal combustion engine being operated.

This arrangement takes account of the fact that, operation of an electric motor at no-load causes more or less pronounced remagnetization losses, thus resulting in unavoidable drag losses. This proposition applies in particular to permanent-magnet motors such as are typically used in hybrid drives, due to their small physical volume. In this case, use is made of the fact that very high differential electric motor efficiencies can be achieved in the transition from drag operation to the generator mode or motor mode. Furthermore, the motor power and the generator power can be controlled or regulated in order to further optimize the fuel consumption.

In one particularly preferred embodiment of the invention, data for changes in the fuel consumption of the internal combustion engine which occur in the event of load changes can be recorded and/or stored as a function of the rotational speed of the internal combustion engine, and the electric motor
is operated as a generator when the quotient of the load change and the consumption change exceeds a first threshold value
and/or
is operated as a motor when the quotient of the load change and the consumption change of the internal combustion engine is less than a second threshold value.

This arrangement makes use of the fact that internal combustion engines are normally provided with automatic engine control which “knows” (or can record) appropriate data in order to minimize their exhaust gas emissions, achieve a desired torque profile, and/or reduce fuel consumption. Such data, which are thus available in any case, can then also be used to optimize the generator mode and/or motor mode of the electric motor.

Overall, this means that the respective differential efficiency (that is, the quotient of load changes and consumption changes of the internal combustion engine) is taken into account for controlling the operation of the electric motor.

In one expedient embodiment of the invention, the generator power and/or the motor power of the electric motor can be controlled analogously to the differential efficiency of the internal combustion engine, by increasing the generator power as the differential efficiency rises in the generator mode, and increasing the motor power as the differential efficiency decreases in the motor mode.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a hybrid drive system;

FIG. 2 is a diagram that illustrates the conditions in which the electric motor or the internal combustion engine is preferably used to drive the vehicle, as a function of the state of charge SOC of the battery and vehicle speed v, in a vehicle with a hybrid drive; and

FIG. 3 shows a family of characteristics, which illustrate schematically the differential efficiency of the internal combustion engine as a function of the rotation speed n and of the mean combustion pressure p and/or the torque t of the internal combustion engine.

### DETAILED DESCRIPTION OF THE DRAWINGS

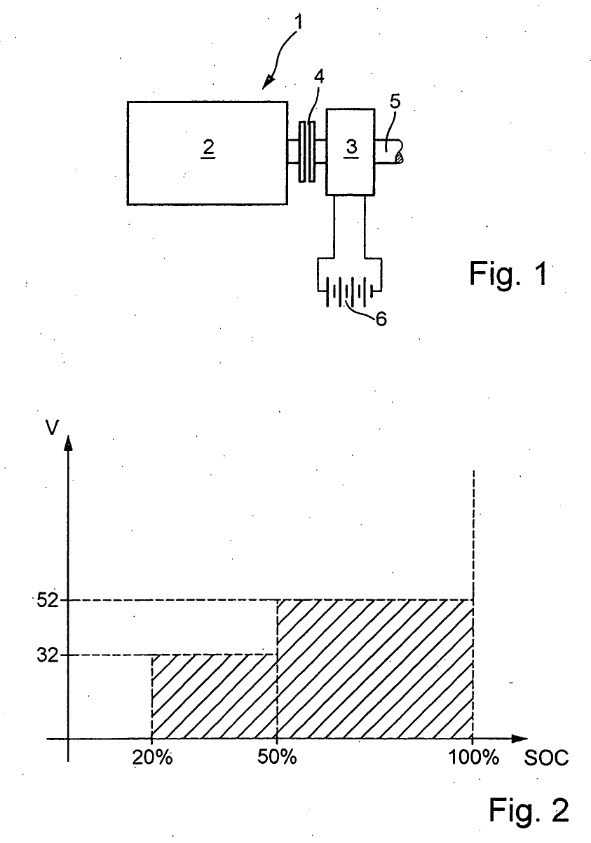

As shown in FIG. 1, a typical hybrid drive 1 essentially comprises an internal combustion engine 2 and an electric motor 3, which can be switched between the motor mode and the generator mode, and whose power is generally considerably less than that of the internal combustion engine 2. An isolating clutch 4 is generally arranged between the internal combustion engine 2 and the electric motor 3.

The rotor shaft of the electric motor 3 forms the output drive 5 of the hybrid drive, which is connected (optionally via a transmission and/or clutch arrangement, not illustrated) to a motor vehicle drive train (not illustrated), when the hybrid drive 1 is arranged in a motor vehicle. When the clutch 4 is disengaged, the hybrid drive 1 can be operated purely by the electric motor; that is, the output drive 5 is driven only by the electric motor 3, with the associated battery 6 providing the electrical power.

When the clutch 4 is engaged, the output drive 5 can be driven by the internal combustion engine 3, in which case the electric motor 3 can be operated as a generator, in order to charge the battery 6. Moreover, the electric motor 3 can be operated in parallel with the internal combustion engine 2 with the clutch 4 engaged, so that both the internal combustion engine 2 and the electric motor 3 drive the output drive 5.

The electric motor 3 can be operated as a generator whenever the aim is to brake the motor vehicle or the drive train which is coupled to the output drive 5. Thus, in this mode, the kinetic energy in the drive train and from the moving vehicle is converted to electrical energy, and stored in the battery 6.

As can be seen from the diagram in FIG. 2, when the state of charge of the battery 6 (SOC) is sufficient, a motor vehicle with a hybrid drive is generally driven exclusively by the electric motor 3 when the vehicle speed (v) is low. At higher vehicle speeds, a change is made to the internal combustion engine 2 to drive the vehicle.

If the state of charge of the battery falls below a threshold value of, for example, 50%, the change to the use of the internal combustion engine for driving the vehicle is made at a lower speed threshold of, for example, 32 km/h. If, in contrast, the state of charge is above 50%, the change to the use of the internal combustion engine to drive the vehicle is generally made only at a speed threshold of, for example, 52 km/h.

If the state of charge of the battery falls below a value of, for example, 20%, the internal combustion engine 2 is used to drive the vehicle.

Switching between the use of the electric motor and the use of the internal combustion engine to drive the vehicle is generally influenced by further parameters, particularly the position of an accelerator pedal or of some other device by means of which the desired power of the hybrid drive is controlled.

If, by way of example, the driver depresses the accelerator pedal to a major extent, this is an indication that he wishes to demand high power from the hybrid drive, for example for rapid acceleration of the vehicle. In typical hybrid drives, the electric motor 3 cannot provide such high power. In a situation such as this, a change is made to the use of the internal combustion engine to drive the vehicle even below the speed of travel thresholds illustrated in FIG. 2, so that the high power desired by the driver is available. As soon as the driver relaxes the load on the accelerator pedal (that is, when he or she is demanding only a comparatively low power from the hybrid drive), the system changes back to the electric motor drive for the vehicle, provided that the speed of travel is below the speed thresholds illustrated by way of example in FIG. 2.

In order to keep the battery 6 within a desired state of charge range, the electric motor 3 must be operated in the generator mode during phases in which the internal combustion engine 2 is being operated.

The invention also takes into account the differential efficiency of the internal combustion engine (that is, the quotient between load changes on the internal combustion engine and corresponding changes in its fuel consumption).

In particular, the invention makes use of the fact that, over a wide range of operating phases, increases in the load on the internal combustion engine lead to only comparatively minor increases in fuel consumption. The invention accordingly provides for the electric motor to be operated as a generator in these operating phases. Moreover, in one expedient refinement of the invention, it is also possible for the generator power of the electric motor to be controlled as a function of the differential efficiency. In operating phases in which particularly minor increases in the fuel consumption of the internal combustion engine occur when the load on the internal combustion engine is increased, the electric motor is thus set to a particularly high generator power.

As is described further below, the abovementioned operating phases occur in particular when the load on the internal combustion engine is low; that is, the electric motor is operated primarily as a generator when the internal combustion engine is required to provide only a reasonable amount of power for the respective driving state of the vehicle.

Furthermore, the invention also makes use of the fact that, in other operating phases of the internal combustion engine (particularly when the internal combustion engine is comparatively heavily loaded), load changes cause relatively major changes in the fuel consumption. According to the invention, in the latter case, the electric motor is preferably operated as a motor in parallel with the internal combustion engine, so that the load on the internal combustion engine is reduced and the fuel consumption is therefore also reduced considerably, because the electric motor provides a portion of the power required for the respective driving state.

In this case, the motor power of the electric motor can be controlled in inverse proportion to the differential efficiency of the internal combustion engine. That is, the electric motor power rises when a load reduction on the internal combustion engine makes it possible to achieve a comparatively major reduction in the fuel consumption of the internal combustion engine.

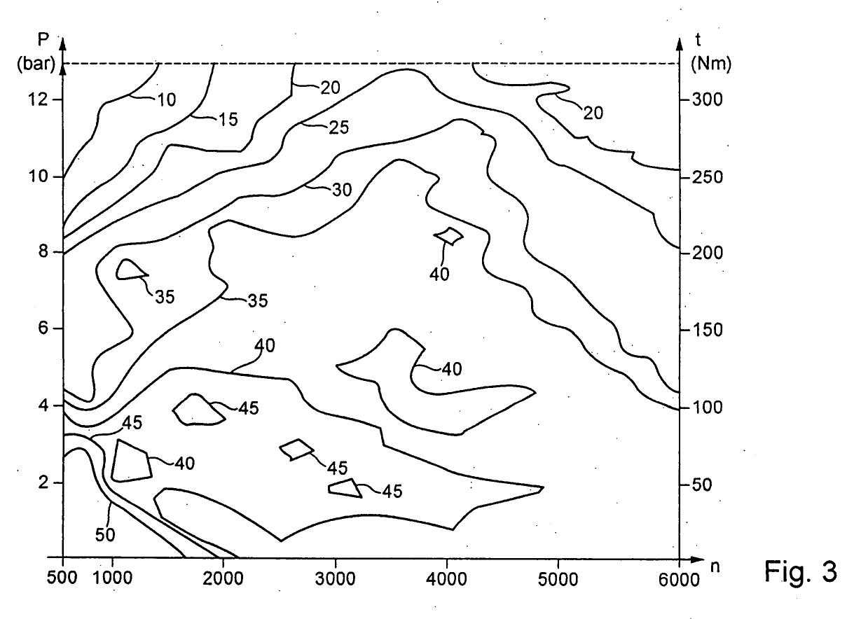

By way of example, FIG. 3 now shows schematically a family of characteristics of the differential efficiency of an internal combustion engine as a function of its rotational speed (n) and the mean pressure (p) in the combustion chambers (which is correlated with the internal combustion engine's torque).

The “contour lines” which are shown in the diagram indicate rotational speed/mean pressure combinations with the same differential efficiency, which is in each case indicated numerically. These figures are obtained by calculation, taking account of the fact that both the load changes on the internal combustion engine and the changes in the fuel consumption associated with them physically represent power changes. This is because the power emitted from the internal combustion engine changes when its load changes. When the fuel consumption changes, the quotient between the energy contained in the fuel and the time changes; that is, the power consumption that is associated with the fuel consumption.

Expressed in simple terms, the diagram in FIG. 3 shows that the differential efficiencies are comparatively high when the load and power of the internal combustion engine are low, and then decrease as the load or power of the internal combustion engine increases.

This situation is equivalent to saying that the absolute efficiency of an internal combustion engine rises comparatively sharply in operating phases with a low load or power as the load or power is increased, while the absolute efficiency of the internal combustion engine no longer rises (or even falls), as the load or power is increased in operating phases in which the load or power is high. Poor situations such as these occur whenever the differential efficiencies are less than the absolute efficiencies, which themselves are currently at best 30% to 35% in the case of an Otto-cycle internal combustion engine.

The invention is not restricted to control of a hybrid drive in which the electric motor operates with the internal combustion engine shut down in specific operating phases. In fact, the invention can be used whenever an internal combustion engine which is provided as the drive engine has an associated electric system which can be operated as an electric motor and generator. In the case of a motor vehicle, an electrical system such as this is used, for example, on the one hand as a starter motor for starting the internal combustion engine, and on the other hand as a generator for charging a battery for the vehicle power supply system. During operation of the internal combustion engine, the electrical system can then be controlled in completely the same manner as has been described above for the electric motor which can be switched between the motor mode and the generator mode in a hybrid system, during operation of the internal combustion engine.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-5. (canceled)

6. In a system comprising an internal combustion engine, an electric motor, a battery electrically coupled to the electric motor and a sensor for recording a state of charge of the battery, wherein i) the motor can be switched between operation in a motor mode and operation in a generator mode, and ii) the motor can be mechanically coupled to the internal combustion engine and/or to an output drive of the system for the purpose of driving said system or for the purpose of said internal combustion engine or said output drive of the system driving the motor in the generator mode, a method of operating said motor, wherein:
when the internal combustion engine is operating and is coupled to the output drive, the electric motor operates,
predominantly in the generator mode only when the load on the internal combustion engine is in a first, relatively lower, range;
and
predominantly in the motor mode when the load on the internal combustion engine is in a second relatively higher, range.

7. The method according to claim 6, wherein:
changes in fuel consumption of the internal combustion engine which occur in response to load changes are recorded as a function of rotational speed of the internal combustion engine, and are stored; and
the electric motor
is operated as a generator when the quotient of a load change and fuel consumption change exceeds a first threshold value;
and
is operated as a motor when the quotient of a load change and fuel consumption is less than the first threshold value or a second threshold value.

8. The method as claimed in claim 7, wherein the electric motor is operated with increasing generator power when the quotient of the load change and the consumption change of the internal combustion engine increases.

9. The method as claimed in claim 8, wherein the electric motor is operated with increasing motor power when the quotient of the load change and consumption change of the internal combustion engine falls.

10. The method as claimed in claim 6, wherein, when the electric motor is continuously positively coupled to the output drive, the electric motor always operates in either the motor mode or the generator mode.

11. The method according to claim 6, wherein the system is a hybrid drive system.

12. The method according to claim 11, wherein the system is a hybrid propulsion system in a motor vehicle.
